(19) United States
(12) Patent Application Publication
(10) Pub. No.: US 2020/0095471 A1
(43) Pub. Date: Mar. 26, 2020

(54) Moisture-Curable Hot-Melt Adhesive Agent

(71) Applicant: Henkel AG & Co. KGaA, Duesseldorf (DE)

(72) Inventors: Kenji Matsuda, Osaka (JP); Ai Takamori, Osaka (JP); Tadashi Hayakawa, Osaka (JP)

(21) Appl. No.: 16/695,768

(22) Filed: Nov. 26, 2019

Related U.S. Application Data
(63) Continuation of application No. PCT/JP2018/019147, filed on May 17, 2018.

(30) Foreign Application Priority Data
May 30, 2017 (JP) 2017-106257

(51) Int. Cl. C09J 7/30; C08L 75/06; C08G 18/10; C08G 18/76; C08G 18/42; C08L 53/02; C08L 25/08; C08L 23/20; C08L 93/04; C08L 91/06; C08K 5/01

(52) U.S. Cl. CPC C09J 7/30; C08L 75/06; C08G 18/10; C08G 18/7671; C08G 18/4261; C08L 53/02; C08L 2203/20; C08L 23/20; C08L 93/04; C08L 91/06; C08K 5/01; C08G 2170/20; C08L 2205/035; C08L 25/08

(57) ABSTRACT

Objective:

To provide a moisture-curable hot-melt adhesive agent having excellent balance of initial adhesive strength, adhesive strength after curing and heat resistance and the like, and a layered product bonded with the moisture-curable hot-melt adhesive agent.

Means for solving the problem: A moisture-curable hot-melt adhesive agent comprising
an urethane prepolymer having an isocyanate group at the end (A),
a styrene based block copolymer (B), and
a tackifying resin (C), wherein
the styrene based block copolymer (B) comprises a styrene based block copolymer having 10 to 35% by weight of a styrene content (B1) and a styrene based block copolymer having 40 to 70% by weight of a styrene content (B2).

### CROSS-REFERENCE TO RELATED APPLICATION

This application claims benefit under Article 4 of the Paris Convention based on Japanese Patent Application No. 2017-106257 filed in Japan on May 30, 2017, incorporated herein by reference in its entirety.

### TECHNICAL FIELD

The present invention relates to a moisture-curable hot-melt adhesive agent.

### BACKGROUND ART

Hot melt adhesive agents are used in various fields such as the field of building interior materials (or the field of building materials) and the field of electronic materials. From the perspectives of not being easily influenced by an external factor and being easily used for a long time, moisture-curable hot-melt adhesive agents attract attention.

Examples of the moisture-curable hot melt adhesive agents include an adhesive agent comprising an urethane prepolymer having an isocyanate group at the end. At least one of a substrate and an adherend is coated with the moisture-curable hot-melt adhesive agent generally in a heated and melted state, and the moisture-curable hot-melt adhesive agent is cooled and solidified thereby initially bonding them together. Then, the isocyanate group is crosslinked by moisture in the air, and the molecular weight of the urethane prepolymer increases by moisture curing, resulting in an improvement in adhesive strength, heat resistance and the like.

One of the performances required for a moisture-curable hot-melt adhesive agent is initial adhesive strength. In order to improve the initial adhesive strength, mixing a tackifying resin in a moisture-curable hot-melt adhesive agent to improve initial wettability on the substrate, or mixing a thermoplastic resin in the hot-melt adhesive agent to improve initial cohesion force or the like is performed.

However, the tackifying resin and the thermoplastic resin did not always have sufficient compatibility with the urethane prepolymer that is a main component of the moisture-curable hot-melt adhesive agent.

Furthermore, in terms of operation, there were problems in that, because the time elapsed until the moisture-curable hot-melt resin was cured after it was applied (open time) was too short, it was difficult to operate, and in that, because the viscosity of the adhesive agent became too high, it was difficult to apply.

Patent Documents 1-3 each disclose a moisture-curable hot-melt adhesive agent including an urethane prepolymer and a thermoplastic resin. The moisture-curable hot-melt adhesive agents in all of the documents include an urethane prepolymer and a styrene based copolymer. The disclosures of Patent Documents 1-3 will hereinafter be specifically described.

Patent Document 1 discloses a reactive hot-melt adhesive agent composition consisting primarily of an urethane prepolymer and a thermoplastic rubber composition (claim 1). In the moisture-curable hot-melt adhesive agent of Patent Document 1, by producing an urethane polymer using a prepolymer of a long-chain polyether having 6 or more carbons, compatibility with the thermoplastic rubber composition is improved, thus providing a reactive hot-melt adhesive composition having excellent compatibility, moisture-curable properties and adhesion properties.

In Patent Document 1, a styrene-ethylene-butylene-styrene (SEBS) block copolymer (Example 1), an urethane prepolymer and a styrene-butadiene-styrene (SBS) block copolymer (Comparative Example 1) and the like are disclosed as a thermoplastic rubber.

Patent Document 2 discloses that, in a reactive hot-melt adhesive composition comprising an urethane prepolymer, a styrene based block copolymer rubber and the like, by using a polyester polyol as a polyether component for synthesizing an urethane prepolymer, the initial adhesion force is improved without considerably decreasing the adhesion force at 50-60° C. In Document 2, a SBS block copolymer (Example 1), a SEBS block copolymer (Example 2) and the like are disclosed as the styrene-based copolymer rubber.

Document 3 discloses that, in a reactive hot-melt type adhesive composition primarily consisting of an urethane prepolymer and a thermoplastic rubber component, by using a saturated hydrocarbon polyol having hydroxyl groups at both ends, compatibility with the thermoplastic rubber component becomes rich, and toughness as well as weatherability including non-yellowing is improved. In Table 1 of Patent Document 3, a styrene-isoprene-styrene (SIS) block copolymer is disclosed as a thermoplastic rubber component. Nineteen to thirty-five parts by weight of the SIS are mixed based on 100 parts by weight in total of the urethane prepolymer and the SIS.

In the moisture-curable hot-melt adhesive agents of Patent Documents 1, 2, the balance of initial adhesive strength and heat resistance is poor. In the moisture-curable hot-melt adhesive agent of Document 3, the initial adhesive strength is extremely poor.

When the amount of a tackifying resin added is adjusted in order to improve the initial adhesive strength of the moisture-curable hot-melt adhesive agent, adhesive strength after curing deteriorates. As described above, it is difficult to produce a moisture-curable hot-melt adhesive agent having an excellent balance of various performances. However, consumers are demanding a moisture-curable hot-melt adhesive agent having an excellent balance of performances.

Therefore, recently, it becomes imperative to develop a moisture-curable hot-melt adhesive agent having an excellent balance of initial adhesive strength, adhesive strength after curing, and heat resistance.

### PRIOR ART DOCUMENTS

### Patent Documents

### Patent Document 1: JP H02-212576 A

### Patent Document 2: JP H06-128552 A

### Patent Document 3: JP H02-272013 A

### SUMMARY OF INVENTION

### Problem to be Solved by the Invention

The present invention was made in order to solve the above problem, and it is an object of the present invention to provide a moisture-curable hot-melt adhesive agent, and a layered product bonded with the moisture-curable hot-melt adhesive agent.

### Means for Solving the Problem

The present invention provides a moisture-curable hot-melt adhesive agent comprising

an urethane prepolymer having an isocyanate group at the end (A),
a styrene based block copolymer (B), and
a tackifying resin (C), wherein
the styrene based block copolymer (B) comprises a styrene based block copolymer having 10 to 35% by weight of a styrene content (B1) and a styrene based block copolymer having 40 to 70% by weight of a styrene content (B2).

In one embodiment, (B1) is a styrene-isoprene based block copolymer, and (B2) is a styrene-isoprene based block copolymer.

In one embodiment, the moisture-curable hot-melt adhesive agent comprises 25 to 64 parts by weight of (A), 10 to 40 parts by weight of (B1) and 10 to 40 parts by weight of (B2), based on 100 parts by weight in total of (A) and (B).

In one embodiment, the moisture-curable hot-melt adhesive agent comprises 60 to 110 parts by weight of the tackifying resin (C), based on 100 parts by weight in total of (A) and (B).

In one embodiment, the styrene based block copolymer (B2) is a triblock copolymer.

The present invention also provides a layered product comprising a substrate, an adhesive agent layer formed on a surface of the substrate and an adherend adhered to a surface of the adhesive agent layer, wherein the adhesive layer consists of any of the moisture-curable hot-melt adhesive agents.

### Effect of the Invention

In the moisture-curable hot-melt adhesive agent of the present invention, the initial adhesive strength, heat resistance and adhesive strength after curing are improved in a balanced manner. In particular, the initial adhesive strength is excellent in a wide range from 5° C. to 35° C., and shows excellent initial adhesive strength at all temperatures including normal temperatures (spring and summer), low temperatures (winter) and high temperatures (summer).

The moisture-curable hot-melt adhesive agent of the present invention has an excellent balance of performances, is applied to various substrates irrespective of seasons and cold and warm regions. Therefore, it can contribute to efficient production of various layered products.

### EMBODIMENT OF THE INVENTION

First, the technical terms used in the present specification will be described.

“Open time” refers to the time from when a melted moisture-curable hot-melt adhesive agent is coated on an adherend until when fluidity of the adhesive agent is lost, so that the adhesive agent cannot wet a surface of the adherend.

“Initial adhesive strength” refers to adhesive strength when the temperature of the moisture-curable hot-melt adhesive agent is lowered resulting in solidification of the adhesive agent after melting and applying the adhesive agent to the adherend. The initial adhesive strength is affected by wettability and cohesion force. Higher initial adhesive strength is preferred.

“Wettability” can be measured by the size of an angle (a) formed by an end of a heated and melted moisture-curable hot-melt adhesive agent and a substrate (solid) when the melted adhesive agent is brought into contact with the substrate. As the a becomes smaller, the wettability becomes higher, and it is easy to adhere.

“Cohesion force” refers to force caused by interaction acting between molecules in an adhesive agent, which occurs during a cooling process after the heated and melted moisture-curable hot-melt adhesive agent is applied using an applicator.

Next, a moisture-curable hot-melt adhesive agent of the present invention will be described.

The moisture-curable hot-melt adhesive agent of the present invention comprises an urethane prepolymer having an 2017234586 US isocyanate group at the end (A), a styrene based block copolymer (B), and a tackifying resin (C), wherein the moisture-curable hot-melt adhesive agent comprises 25 to 64 parts by weight of (A), based on 100 parts by weight in total of (A) and (B).

In the present specification, the moisture-curable hot-melt adhesive agent is also simply referred to as the “hot-melt adhesive agent”.

The respective components included in the moisture-curable hot-melt adhesive agent of the present application will hereinafter be described.

### (A) Urethane Prepolymer Having Terminal Isocyanate Groups

The moisture-curable hot-melt adhesive agent of the present invention includes an urethane prepolymer having terminal isocyanate groups (A) (hereinafter also referred to as “component (A)”). The urethane polymer having terminal isocyanate groups is usually understood as a “urethane prepolymer”. Those having an “isocyanate group at the end” are not particularly limited as long as the intended moisture-curable hot-melt adhesive agent is obtained.

Such an urethane prepolymer is obtained by reacting a polyol and an isocyanate compound according to a known method.

In the present specification, the “polyol” is not particularly limited as long as the intended urethane prepolymer can be obtained. Publicly known polyols used for the usual production of polyurethanes can be used. As the polyols, those having a functional group number of 1 to 3 are preferred, particularly difunctional polyols, so-called diols are preferred. The polyols can be used alone or in combination thereof. Examples of the diols include low molecular weight diols such as ethylene glycol, 1-methylethylene glycol, 1-ethylethylene glycol, propylene glycol, butanediol, pentanediol, hexanediol, heptanediol, octanediol, nonanediol, decanediol, neopentyl glycol, 2-methyl-1,3-propanediol, cyclohexane dimethanol, and 2,4-dimethyl-1,5-pentanediol. At least one kind selected from ethylene glycol, butanediol, hexanediol, octanediol and decanediol is preferred. These diols can be used singly or in combination thereof.

Examples of the “polyols” in the present invention also include a polyether polyol, a polyester polyol and the like.

Examples of the polyester polyol include, for example, polyoxytetramethylene glycol (PTMG), polyoxypropylene glycol (PPG), polyoxyethylene glycol (PEG) and the like. Polyoxypropylene glycol is particularly preferred as the polyether polyol.

An aromatic polyester polyol and an aliphatic polyester polyol can be exemplified as the polyester polyols in the present invention.

The aromatic polyester polyol is preferably obtained by reacting an aromatic carboxylic acid and a diol. As the aromatic polycarboxylic acid, for example, phthalic acid, isophthalic acid, terephthalic acid, hexahydroisophthalic acid and the like can be exemplified. These may be used alone or in combination of two or more thereof. Polyalkylene phthalate, polyalkylene isophthalate and polyalkylene terephthalate, each of which having terminal OH groups, can be given as an example of the aromatic polyester polyol. As the aromatic polyester polyol, polyalkylene phthalate having terminal OH groups is particularly preferable.

The aliphatic polyester polyol is obtained by reacting an aliphatic carboxylic acid and a diol. For example, as the aliphatic carboxylic acid, adipic acid, sebacic acid, azelaic acid and decamethylene dicarboxylic acid can be exemplified. These may be used alone or in combination of two or more thereof. Polyhexamethylene adipate (PHMA) and polybutylene adipate (PBA), each of which having terminal OH groups, can be given as an example of the aliphatic polyester polyol. As the aliphatic polyester polyols, polyhexamethylene adipate having terminal OH groups is particularly preferable.

In the present invention, examples of particularly preferred embodiments of the polyols include aliphatic polyester polyols. The aliphatic polyester polyols may be used alone or in combination of two or more different kinds thereof.

The number-average molecular weight of the polyols is not particularly limited, and preferably 1,000 to 7,000. In the present specification, the weight-average molecular weight or number-average molecular weight is measured by gel permeation chromatography (GPC) using a calibration curve using monodisperse molecular weight polystyrene as a standard substance to convert molecular weight.

In the present invention, the isocyanate compound is not particularly limited as long as the intended urethane prepolymer can be obtained, and those used for the conventional production of polyurethanes can be used. The isocyanate compound preferably has from 1 to 3 isocyanate groups per molecule on an average, and is particularly preferably a difunctional isocyanate compound, a so-called diisocyanate compound. The isocyanate compounds may be used alone, or in combination of two or more kinds thereof.

As the “isocyanate compound”, for example, ethylene diisocyanate, ethylidene diisocyanate, propylene diisocyanate, butylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,2′-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, furfurylidene diisocyanate, 1-chlorobenzene-2,4-diisocyanate and the like can be exemplified. These isocyanate compounds may be used alone or in combination thereof.

When producing the “urethane prepolymer” according to the present invention, a monool and a monoisocyanate may be used, and also a trifunctional polyol and a trifunctional isocyanate may also be used as long as the intended urethane prepolymer can be obtained. However, it is preferred to produce it by using at least a difunctional polyol (diol) and a difunctional isocyanate (diisocyanate compound). It is more preferred that the “urethane prepolymer” is produced by reacting a difunctional polyol with a difunctional isocyanate compound from the viewpoint of the thermal stability and easy to control of production method (and production process thereof) of the obtainable moisture-curable hot melt adhesive agent.

In order to produce the urethane prepolymer having terminal isocyanate groups (A), a polyol and an isocyanate compound are mixed so that the lower limit of the molar ratio of NCO groups and OH groups (NCO/OH) is preferably 1.3 or more, more preferably 2 or more, and the upper limit thereof is preferably 3 or less. In addition, it is preferred to use about 2 mol (about from 1.8 mol to 2.3 mol) of a difunctional isocyanate based on 1 mol of difunctional polyol because the intended urethane prepolymer can be produced relatively easily.

### (B) Styrene Based Block Copolymer

The moisture-curable hot-melt adhesive agent of the present invention includes a styrene-isoprene based block copolymer (B) (hereinafter also referred to as “component (B)”). The styrene based block copolymer (B) is a copolymer obtained by block copolymerization of styrene that is a vinyl class aromatic hydrocarbon with a conjugated diene compound, and is usually a resin composition including a product comprised of styrene blocks and conjugated diene compound blocks.

The “conjugated diene compound” means a diolefin compound having at least a pair of conjugated double bonds. Specific examples of the “conjugated diene compound” can include 1,3-butadiene, 2-methyl-1,3-butadiene (or isoprene), 2,3-dimethyl-1,3-butadiene, 1,3-pentadiene, and 1,3-hexadiene. Particularly, 1,3-butadiene and 2-methyl-1,3-butadiene are preferable. These conjugated diene compounds can be used alone or in combination thereof.

The thermoplastic block copolymer (B) according to the present invention may be either an unhydrogenated product or a hydrogenated product.

Specific examples of the “unhydrogenated product of the styrene based block copolymer (B)” include those in which the conjugated diene compound blocks are not hydrogenated.

Specific examples of the “hydrogenated product of the styrene based block copolymer (B)” include block copolymers in which the conjugated diene compound blocks are entirely or partially hydrogenated.

The ratio that the “hydrogenated product of the styrene based block copolymer (B)” is being hydrogenated can be indicated by “hydrogenation ratio”. The “hydrogenation ratio” of the “hydrogenated product of the styrene based block copolymer (B)” refers to the ratio of double bonds converted into saturated hydrocarbon bonds by hydrogenation on the basis of all aliphatic double bonds included in the conjugated diene compound blocks. The “hydrogenation ratio” can be measured by an infrared spectrophotometer, a nuclear magnetic resonance spectrometer, and the like.

For example, a styrene-isoprene block copolymer (“SIS”) and a styrene-butadiene block copolymer (“SBS”) can be specifically exemplified as the “unhydrogenated product of the styrene based block copolymer (B)”.

A styrene-ethylene/propylene-styrene block copolymer (also referred to as “SEPS”), a styrene-ethylene/butylene-styrene block copolymer (also referred to as “SEBS”) and the like can be specifically exemplified as the “hydrogenated product of the styrene based block copolymer (B)”.

The styrene based block copolymer (B) may be either a radial type, a linear type, or a triblock type as long as the object of the present invention is not impaired.

In the present invention, the styrene based block copolymer (B) preferably includes a styrene-based block copolymer having a styrene content of 15 wt. % or more, and particularly preferably includes both a styrene-based block copolymer having a styrene content of 15 to 35 wt. % (B1), and a styrene based block copolymer having a styrene content of 40 to 60 wt. % (B2).

By including both the (A) and the (B) in the hot-melt adhesive agent of the present invention, the balance of the initial adhesive strength, the adhesive strength after curing, and the heat resistance becomes more excellent.

In the present invention, it is more preferred that the (B1) includes a styrene-isoprene based block copolymer, and that the (B2) includes a styrene-isoprene based block copolymer.

In the present specification, the “styrene content” means the ratio of styrene blocks contained in the “styrene-based block copolymer (B)”.

In the present invention, the styrene-based block copolymer (B1) having a styrene content of 15 to 35 wt. % preferably has a diblock content of 30 to 70 wt. %, and most preferably 35 to 60 wt. %.

In the present invention, the styrene-based block copolymer having a styrene content of 40 to 70 wt. % (B2) preferably has a diblock content of less than 40 wt. %, especially preferably not more than 30 wt. %, and most preferably 0 wt. %. The styrene based block copolymer having a diblock content of 0 wt. % (B2) becomes a triblock copolymer.

In the present specification, the “diblock content” means the ratio of styrene-conjugated diene compound block copolymers contained in the (B). The diblock is represented by the following formula (1):

[Chemical Formula 1]

S-E (1)

In formula (1), S is a styrene block, and E is a conjugated diene compound block.

Commercialized products can be used as the styrene-based block copolymer (B) of the present invention.

For example, as the (B1), Asaprene T432 manufactured by Asahi Kasei Corporation, which is a styrene-butadiene-styrene block copolymer; Quintac SL-165 (manufactured by ZEON CORPORATION), Vector 4411A (manufactured by Dexco Corporation), Vector 4211A (manufactured by Dexco Corporation), Quintac 3270 (manufactured by ZEON CORPORATION), Quintac 3460 (manufactured by ZEON CORPORATION), Quintac 3433N (manufactured by ZEON CORPORATION), Quintac 3450 (manufactured by ZEON CORPORATION) and the like, which are styrene-isoprene-styrene block copolymers, and the like can be exemplified.

Examples of the (B2) include Asaprene T439 (manufactured by Asahi Kasei Chemicals Corporation), which is a styrene-butadiene-styrene block copolymer; Clayton D1162 (manufactured by Clayton Corporation), Quintac 3390 (manufactured by ZEON CORPORATION), and Quintac SL-168 (manufactured by Zeon CORPORATION), which are styrene-isoprene-styrene block copolymers.

The respective components of these commercialized products can each be used alone or in combination of two or more kinds thereof.

### (C) Tackifying Resin

The moisture-curable hot-melt adhesive agent according to the present invention includes a tackifying resin (C) (hereinafter also referred to as “component (C)”), The tackifying resin (C) is not particularly limited as long as it is usually used and the moisture-curable hot-melt adhesive agent at which the present invention aims can be obtained.

Examples of the tackifying resin (C) can include, for example, natural rosin, modified rosin, hydrogenated rosin, a glycerol ester of natural rosin, a glycerol ester of modified rosin, a pentaerythritol ester of natural rosin, a pentaerythritol ester of modified rosin, a pentaerythritol ester of hydrogenated rosin, a copolymer of natural terpene, a three dimensional polymer of natural terpene, hydrogenated derivatives of a copolymer of hydrogenated terpene, polyterpene resin, hydrogenated derivatives of a phenol-based modified terpene resin, an aliphatic petroleum hydrocarbon resin, hydrogenated derivatives of an aliphatic petroleum hydrocarbon resin, an aromatic petroleum hydrocarbon resin, hydrogenated derivatives of an aromatic petroleum hydrocarbon resin, a cyclic aliphatic petroleum hydrocarbon resin, and hydrogenated derivatives of a cyclic aliphatic petroleum hydrocarbon resin. These tackifying resins can be used alone or in combination thereof.

As long as the object of the present invention is achieved, the tackifying resins may be modified products of these resins (for example, modified rosin having a chemical bond and a functional group). The “modified rosin” in the present specification means rosin having an amino group, a maleic acid group, an epoxy group, a hydroxyl group, an urethane bond, an amide bond and the like.

Commercialized products can be used as the tackifying resin (C). Examples of such commercialized products can include, for example, MARUKACLEAR H (trade name) manufactured by MARUZEN PETROCHEMICAL CO., LTD., Clearon K100 (trade name), Clearon K4090 (trade name) and Clearon K4100 (trade name) manufactured by YASUHARA CHEMICAL CO., LTD., Arkon M-100 (trade name) manufactured by Arakawa Chemical Industries, Ltd., I-Mary 5110 (trade name) manufactured by Idemitsu Kosan Co., Ltd., T-REZ HA103 (trade name), T-REZ HA125 (trade name) and T-REZ HC103 (trade name) manufactured by Tonen General Sekiyu K.K, Regalite R7100 (trade name) manufactured by Eastman Chemical Co., Ltd. These commercialized tackifying resins may be used alone or in combination thereof.

In the moisture-curable hot-melt adhesive agent of the present invention, the contents of components (A), (B) and (C) can be defined based on 100 parts by weight in total of the urethane prepolymer having an isocyanate group at the end (A) and the styrene-isoprene based block copolymer (B). That is, they are as follows:

component (A): commonly 25 to 64 parts by weight, preferably 30 to 63 parts by weight, more preferably 50 to 60 parts by weight;
component (B1): commonly 5 to 40 parts by weight, preferably 10 to 35 parts by weight;
component (B2): commonly 5 to 40 parts by weight, preferably 20 to 35 parts by weight; and
component (C): commonly 60 to 110 parts by weight, preferably 70 to 100 parts by weight, more preferably 80 to 90 parts by weight.

By including the respective components in the above ratio, the balance of the initial adhesive strength, the heat resistance, and the adhesive strength after curing becomes excellent.

### (D) Plasticizer

The moisture-curable hot-melt adhesive agent of the present invention preferably includes a plasticizer (D) in addition to components (A) to (C). The plasticizer (D) keeps viscosity of the moisture-curable hot-melt adhesive agent low to some extent while improving compatibility of components (A) to (C). Since the moisture-curable hot-melt adhesive agent has a low viscosity, it has excellent coating properties, and its wettability on the adherend is improved. Consequently, the initial adhesive strength is improved.

In the present invention, the plasticizer (D) is not particularly limited as long as it is usually used, and the moisture-curable hot-melt adhesive agent at which the present invention aims can be obtained.

Examples of the plasticizer (D) can include paraffin-based oil, naphthene-based oil and aromatic-based oil, dioctyl phthalate, dibutyl phthalate, dioctyl adipate, and mineral spirits.

As the plasticizer (D), commercialized products can be used. Examples thereof can include, for example, White Oil Broom 350 (trade name) manufactured by Kukdong Oil & Chemicals Co., Ltd.; Diana Fresia S32 (trade name), Diana Process Oil PW-90 (trade name) and DN Oil KP-68 (trade name) manufactured by IDEMITSU KOSAN CO., LTD.; Enerper M1930 (trade name) manufactured by BP Chemicals, Inc.; Kaydol (trade name) manufactured by Crompton Corporation; Primol 352 (trade name) manufactured by ESSO Corp.; Process Oil NS100 manufactured by IDEMITSU KOSAN CO., LTD.; and KN 4010 (trade name) manufactured by PetroChina Company Limited. These plasticizers (D) can be used alone or in combination thereof.

The moisture-curable hot-melt resin of the present invention may further include other additives. The “additives” are not particularly limited as long as they are usually used for moisture-curable hot-melt adhesive agents, and can be used for the moisture-curable hot-melt adhesive agent of the present invention. Examples of such additives can include, for example, a plasticizer, an antioxidant, a pigment, a photostabilizer, a flame retardant, a catalyst, a wax, and the like.

As the “antioxidant”, for example, a phenol-based antioxidant, a phosphite-based antioxidant, a thioether-based antioxidant, an amine-based antioxidant, and the like can be exemplified.

As the “pigment”, for example, titanium oxide, carbon black, and the like can be exemplified.

As the “photostabilizer”, for example, benzotriazole, hindered amine, benzoate, benzotriazole, and the like can be exemplified.

As the “flame retardant”, for example, a halogen-based flame retardant, a phosphorous-based flame retardant, an antimony-based flame retardant, a metal hydroxide-based flame retardant, and the like can be exemplified.

As the “catalyst”, metal-based catalysts such as tin-based catalysts (trimethyltin laurate, trimethyltin hydroxide, dibutyltin dilaurate, and dibutyltin maleate, etc.), lead-based catalysts (lead oleate, lead naphthenate, and lead octenoate, etc.), and other metal-based catalysts (naphthenic acid metal salts such as cobalt naphthenate) and amine-based catalysts such as triethylene diamine, tetramethylethylene diamine, tetramethylhexylene diamine, diazabicycloalkenes, dialkylaminoalkylamines, and the like can be exemplified.

As the “wax”, for example, waxes such as paraffin wax and microcrystalline wax can be exemplified.

In the method for producing the moisture-curable hot melt adhesive of the present invention, the mixing order of the respective components, mixing method and the like are not particularly limited, as long as the method includes mixing the respective components and the additive(s) as necessary. One or both of a polyol and an isocyanate compound for obtaining an urethane prepolymer having terminal isocyanate groups (A) (component (A)) and the other components (B) and (C) may be mixed at the same time; or after producing an urethane prepolymer having terminal isocyanate groups by reacting a polyol and an isocyanate compound, the resultant product may be mixed with the other components.

The moisture-curable hot-melt adhesive agent of the present invention can be produced by heating, melting and mixing the components. For example, the above components are charged into a melt-mixer equipped with a stirrer, and the mixture is heated and mixed to produce it.

The moisture-curable hot-melt adhesive agent of the present invention obtained in this manner is a reactive hot-melt adhesive agent, which is solid at room temperature. The reactive hot-melt adhesive agent can be used with a known method. Generally, the moisture-curable hot-melt adhesive agent is heated and melted for use.

### Layered Product

A layered product of the present invention includes the above moisture-curable hot-melt adhesive agent. The layered product is produced by laminating an “adherend” on the surface of a “substrate”. When producing the layered product, the moisture-curable hot-melt adhesive agent may be applied to the substrate side, the adherend side, or both the sides. Here, materials of the adherend and the substrate and forms thereof, etc. may be the same or different.

The “substrate” is not particularly limited, and the following can be given as examples:

Woody materials such as plywood (for example, lauan plywood), a medium density fiberboard (MDF), a particle board, a solid wood, and a wood fiberboard;

inorganic materials such as a cement board, a gypsum plaster board, and an autoclaved lightweight concrete (ALC); and plastic materials such as polyethylene terephthalate, polycarbonate, polyurethane, polyethylene and polypropylene.

The form of the “substrate” is not also particularly limited, and it may be molded resin-type, film-type, or sheet-type.

The “adherend” may be those conventionally used, and is not particularly limited. Specifically, a film, a sheet and the like can be exemplified.

The film may be either colorless or colored, or either transparent or opaque. For example, films made of a polyolefin resin, a polyester resin, an acetate resin, a polystyrene resin, a vinyl chloride resin, and the like can be exemplified. As the polyolefin resin, for example, polyethylene and polypropylene can be exemplified. As the polyester resin, for example, polyethylene terephthalate can be exemplified.

The adherend may be a decorative sheet. The following can be given as examples of the decorative sheet:

Sheets made of plastic materials such as a rigid or semi-rigid vinyl chloride resin, a polyolefin resin, and a polyester resin;

boards obtained by slicing wood into a sheet; and

decorative papers subjected to various decorative printings.

The layered product of the present invention may specifically be available for various uses such as building materials, furniture, electronic materials and in automobiles.

It is not necessary to use a special apparatus so as to produce the layered product. The layered product may be produced by using a commonly known production apparatus including a conveyer, a coater, a press, a heater and a cutter.

For example, a layered product may be produced by the following procedure. While transporting a substrate and an adherend by a conveyor, the moisture-curable hot-melt adhesive agent according to the present invention is applied to the substrate or the adherend by a coater. The temperature during the application is controlled at a predetermined temperature by a heater. The adherend and the substrate are laminated on each other via the moisture-curable hot-melt adhesive agent by slightly pressing the adherend against the substrate using a press. Then, the laminated adherend and substrate are left standing to cool, and transported by the conveyer as they are, thereby solidifying the moisture-curable hot melt adhesive agent. Thereafter, the substrate laminated with the adherend is cut into an appropriate size by a cutter.

The moisture-curable hot-melt adhesive agent of the present invention has high initial adhesive strength, adhesive strength even after curing, and also excellent heat resistance, whereby layered products of the present invention are efficiently produced, resulting in products excellent in various qualities.

### EXAMPLES

The present invention will hereinafter be described by using Examples and Comparative Examples. These Examples are merely for illustrative purposes and are not meant to limit the present invention in any way.

Components for producing the hot melt adhesive are shown below.

### (A) Materials for Constituting an Urethane Prepolymer Having Terminal Isocyanate Groups

Polyol Component

(A1) polyester polyol (HS2F-231AS (trade name) manufactured by Hokoku Corporation, melting point: 30° C., hydroxyl value: 56 (mgKOH/g))
(A2) polyester polyol (HS2H-350S (trade name) manufactured by Hokoku Corporation, melting point: −5° C., hydroxyl value: 32 (mgKOH/g))
(A3) polyester polyol (HS2E-581A (trade name) manufactured by Hokoku Corporation, melting point: −5° C., hydroxyl value: 21 (mgKOH/g))
(A4) polypropylene glycol (High-Flex D-2000 (trade name) manufactured by Dai-ichi Kogyo Seiyaku Co., Ltd., hydroxyl value: 56 (mgKOH/g)

### Isocyanate Component

(A5) 4,4′-diphenylmethane diisocyanate (Millionate MT (trade name) manufactured by Tosoh Corporation)

### (B) Styrene Based Block Copolymer

(B1-1) styrene-isoprene block copolymer (JSR5403 (trade name) manufactured by JSR Corporation, styrene content: 15 wt %, diblock content: 40 wt %, MFR 20 g/10 min.: 200° C.
(B1-2) styrene-isoprene block copolymer (Quintac 3433N (trade name) manufactured by Zeon Corporation, styrene content: 16 wt %, diblock content: 56 wt %, MFR 12 g/10 min.: 200° C.
(B1-3) styrene-isoprene block copolymer (Quintac 3270 (trade name) manufactured by Zeon Corporation, styrene content: 24 wt %, diblock content: 67 wt %, MFR 20 g/10 min.: 200° C.
(B1-4) styrene-isoprene block copolymer (Quintac SL-165 (trade name) manufactured by Zeon Corporation, styrene content: 30 wt %, diblock content: 60 wt %, MFR 16 g/10 min.: 200° C.
(B1-5) styrene-butadiene block copolymer (Asaprene T432 (trade name) manufactured by Asahi Kasei Chemicals Corporation, styrene content: 30 wt %, diblock content: 25 wt %, MFR 0.2 g/10 min.: 200° C.)

(B2-1) styrene-isoprene block copolymer (D1162 (trade name) manufactured by Clayton Corporation, styrene content: 43 wt %, diblock content: 0 wt % (triblock copolymer), MFR 45 g/10 min.: 200° C.)

(B2-2) styrene-butadiene block copolymer (Asaprene T439 (trade name) manufactured by Asahi Kasei Chemicals Corporation, styrene content: 45 wt %, diblock content: 62 wt %, MFR not publicly disclosed)
(B2-3) styrene-butadiene block copolymer (TR2250 (trade name) manufactured by JSR Corporation, styrene content: 52 wt %, diblock content: 0 wt % (triblock copolymer), MFR 4.0 g/10 min.: 200° C.)
(B2-4) styrene-butadiene-butylene block copolymer (Tuftec P2000 (trade name) manufactured by Asahi Kasei Chemicals Corporation, styrene content: 67 wt %, diblock content: 0 wt % (triblock copolymer), MFR 3.0 g/10 min.: 190° C.)

### (C) Tackifying Resin

(C1) Unhydrogenated C5 resin (WINGTACK 86 (trade name) manufactured by Cray Valley LLC., softening point: 87° C.)
(C2) Fully hydrogenated DCPD resin (T-REZ HA103 (trade name) manufactured by Tonen General Sekiyu K.K, softening point: 103° C.)
(C3) Partially hydrogenated C9 resin (Arkon M-100 (trade name) manufactured by Arakawa Chemical Industries, Ltd.)
(C4) Fully hydrogenated C9 resin (Arkon P-125 (trade name) manufactured by Arakawa Chemical Industries, Ltd.)
(C5) Urethane modified rosin (the production method is described below (Table 1))
(C6) Urethane modified rosin (the production method is described below (Table 1)
(C7) Urethane modified rosin (the production method is described below (Table 1)
(C8) Urethane modified rosin (the production method is described below (Table 1)

(D) Plasticizer

(D1) Naphthene oil (SUNPURE N90 (trade name) manufactured by JAPAN SUN OIL COMPANY, LTD.)
(D2) Paraffin oil (DUPHNE OIL KP68 (trade name) manufactured by Idemitsu Kosan Co., Ltd.
(D3) Rice oil (Rice Salad Oil (trade name) manufactured by Boso Yushi Co., Ltd.)

### (E) Other Additives

(E1) Antioxidant (Adekastab AO-60 (trade name) manufactured by ADEKA CORPORATION)

Production of Moisture-Curable Hot-Melt Adhesive Agent

A method for producing urethane modified rosin will be described.

First, a rosin ester component (F) was charged in a reaction container, and the rosin ester component was melted in an oven at 130° C. Thereafter, it was stirred under reduced pressure for one hour while heating the reaction container in an oil bath at 130° C. to remove its moisture. Subsequently, an isocyanate component (A5) or (G1) was charged in a NCO/OH ratio of 1.05, and the mixture was stirred under reduced pressure for one hour at 130° C. to obtain urethane modified rosin (C).

The urethane modified rosin was subjected to infrared spectroscopic analysis (FT-IR analysis). It was confirmed that the absorption at 2300 cm⁻¹ due to the isocyanate group, and the absorption at 3400 cm⁻¹ due to the hydroxyl group almost disappeared.

Combinations of the rosin ester component and the isocyanate component are as shown in Table 1.

TABLE 1

| Urethane Modified Rosin | Combination of Components |
|---|---|
| (C5) | (F1) |
| | (A5) |
| (C6) | (F1) |
| | (G1) |
| (C7) | (F2) |
| | (G1) |
| (C8) | (F3) |
| | (G1) |

### (F) Rosin Ester as a Constituent of Urethane Modified Rosin

(F1) Rosin ester resin having hydroxyl groups (SYLVALITE RE 85 GB (trade name) manufactured by Arizona Chemical Company, LLC., softening point: 85° C., hydroxyl value: 25 (mgKOH/g))
(F2) Rosin ester resin having hydroxyl groups (SYLVALITE RE 105L (trade name) manufactured by Arizona Chemical Company, LLC., softening point: 105° C., hydroxyl value: 10 (mgKOH/g))
(F3) Rosin ester resin having hydroxyl groups (Super Ester T125 (trade name) manufactured by Arakawa Chemical Industries, Ltd., softening point: 125° C., hydroxyl value: 7 (mgKOH/g))

### (G) Isocyanate as a Constituent of Urethane Modified Rosin

(G1) p-Toluenesulphonyl Isocyanate

### Example 1

Components (A) to (E) were mixed to produce a moisture-curable hot-melt adhesive agent.

Specifically, components (B1-4), (B2-1), (C3), (C4), (C5), (D1) and (E1) were melt-mixed in the composition (part by weight) shown in Table 2 by a universal agitator to prepare a melted composition.

Then, polyester polyols (A3) and the above melted compositions were mixed in the composition shown in Table 2 (part by weight). The mixture was put in a reaction container. After heating the mixture at 130° C., the mixture was stirred under reduced pressure for one hour at the same temperature. After confirming that moisture has been removed and that the mixture has been sufficiently kneaded, 4,4′-diphenylmethane diisocyanate (A5) was added thereto, and the mixture was stirred under reduced pressure for one hour at the same temperature to obtain a moisture-curable hot-melt adhesive agent.

### Examples 2-7, Comparative Examples 1-4

In the compositions shown in Tables 2 and 4, components (A) to (E) were prepared in the same process as in Example 1 to produce moisture-curable hot-melt adhesive agents.

With regard to the thus obtained moisture-curable hot-melt adhesive agents, the melt viscosity, heat resistance (creeping test), initial adhesive strength (tack), and adhesive strength after curing (durability test) were measured. The results are shown in Tables 3 and 5.

TABLE 2

| Raw material | Raw material | Raw material | | | | | | | |
|---|---|---|---|---|---|---|---|---|---|
| classification 1 | classification 2 | classification 3 | Example 1 | Example 2 | Example 3 | Example 4 | Example 5 | Example 6 | Example 7 |
| Urethane | Polyol | (A1) | | | | | | 36.6 | |
| prepolymer | | (A2) | | | | | | 11.0 | |
| (A) | | (A3) | 57.5 | 53.3 | 54.6 | 19.2 | 60.7 | | 58.1 |
| | | (A4) | | | | 7.69 | | | |
| | Isocyanate | (A5) | 5.7 | 6.1 | 5.4 | 3.8 | 6.0 | 8.5 | 5.7 |
| Styrene | Low St | (B1-1) | | | 20.0 | | | | |
| based block | content (B1) | (B1-2) | | 16.8 | | | | 24.4 | |
| copolymer | | (B1-3) | | | | 34.6 | | | |
| (B) | | (B1-4) | 14.7 | | | | | | 29.8 |
| | | (B1-5) | | | | | 11.1 | | |
| | High St | (B2-1) | 22.1 | 23.8 | 20.0 | 34.6 | | | |
| | content (B2) | (B2-2) | | | | | 22.2 | | |
| | | (B2-3) | | | | | | 19.5 | |
| | | (B2-4) | | | | | | | 6.4 |

| Tackifying resin (C) | (C1) | | | 32.0 | | 44.4 | 34.9 | 38.3 |
|---|---|---|---|---|---|---|---|---|
| | (C2) | | 14.5 | | | | | |
| | (C3) | 10.5 | | | | | | |
| | (C4) | 23.2 | 25.7 | | | | | |
| | (C5) | 56.1 | 39.4 | | | | | |
| | (C6) | | | | 41.4 | 36.4 | | |
| | (C7) | | | 41.5 | | 23.0 | 63.3 | 44.1 |
| | (C8) | | | | | | 12.5 | |
| Plasticizer (D) | (D1) | 24.2 | | 28.0 | | 22.2 | 35.9 | 31.9 |
| | (D2) | | 14.9 | | | | | |
| | (D3) | | | | 28.8 | | | |
| Additive (E) | (E1) | 0.4 | 0.4 | 0.4 | 0.4 | 0.4 | 0.4 | 0.4 |

| | | | | | | | |
|---|---|---|---|---|---|---|---|
| NCO/OH (Ratio of functional groups) | 2.1 | 2.5 | 2.1 | 2.1 | 2.1 | 1.6 | 2.1 |
| Total | 210.95 | 191.09 | 200.00 | 163.85 | 222.22 | 243.90 | 212.77 |

The unit of amount shown in Table 2 is part by weight.

TABLE 3

| Measurement Item | | Ex. 1 | Ex. 2 | Ex. 3 | Ex. 4 | Ex. 5 | Ex. 6 | Ex. 7 |
|---|---|---|---|---|---|---|---|---|
| Viscosity (mPas) | | 33500 | 50300 | 70600 | 53500 | 33250 | 77000 | 83000 |
| Creep (min) | | 9.6 | 6.8 | 7.6 | 3.3 | 6.3 | 4.8 | 6.5 |
| Evaluation of heat resistance | | ⊚ | ◯ | ⊚ | Δ | ◯ | Δ | ◯ |
| Tack (g/cm²) | 5° C. | 3100 | 2560 | 2100 | 3461 | 1720 | 1920 | 2220 |
| | 23° C. | 3650 | 4100 | 2400 | 4100 | 2710 | 2530 | 2630 |
| | 35° C. | 4400 | 3000 | 4100 | 4710 | 3380 | 2980 | 3140 |
| Evaluation of | 5° C. | ◯ | ◯ | Δ | ◯ | Δ | Δ | Δ |
| Initial adhesive | 23° C. | ⊚ | ⊚ | Δ | ⊚ | ◯ | ◯ | ◯ |
| strength | 35° C. | ⊚ | ◯ | ⊚ | ⊚ | ◯ | ◯ | ◯ |

| | | | | | | | |
|---|---|---|---|---|---|---|---|
| Evaluation of adhesive | ◯ | ◯ | ◯ | ◯ | ◯ | ◯ | ◯ |
| strength after curing | | | | | | | |

TABLE 4

| Raw material | Raw material | Raw material | Comp. | Comp. | Comp. | Comp. |
|---|---|---|---|---|---|---|
| classification 1 | classification 2 | classification 3 | Example 1 | Example 2 | Example 3 | Example 4 |
| Urethane | Polyol | (A1) | | | | |
| prepolymer | | (A2) | | | | |
| (A) | | (A3) | 56.9 | 47.5 | 54.6 | 56.9 |
| | | (A4) | | | | |
| | Isocyanate | (A5) | 5.6 | 2.5 | 5.4 | 5.6 |
| Styrene | Low St | (B1-1) | | | | |
| based block | content (B1) | (B1-2) | | | 20.0 | |
| copolymer | | (B1-3) | 37.5 | | 20.0 | |
| (B) | | (B1-4) | | | | |
| | | (B1-5) | | | | |
| | High St | (B2-1) | | 50.0 | | 20.8 |
| | content (B2) | (B2-2) | | | | |
| | | (B2-3) | | | | 16.7 |
| | | (B2-4) | | | | |

| Tackifying resin (C) | (C1) | 41.7 | | 40.0 | 41.7 |
|---|---|---|---|---|---|
| | (C2) | | 35.0 | | |
| | (C3) | | | | |
| | (C4) | | | | |
| | (C5) | | | | |
| | (C6) | | 54.6 | | 41.0 |
| | (C7) | 38.9 | | 41.5 | |
| | (C8) | | | | |
| Plasticizer (D) | (D1) | 29.2 | 40.0 | 20.0 | 29.2 |
| | (D2) | | | | |
| | (D3) | | | | 28.8 |
| Additive (E) | (E1) | 0.4 | 0.4 | 0.4 | 0.4 |

| | | | | |
|---|---|---|---|---|
| NCO/OH (Ratio of functional groups) | 2.1 | 1.6 | 2.1 | 2.1 |
| Total | 208.33 | 225.00 | 200.00 | 208.33 |

The unit of amount shown in Table 4 is part by weight.

TABLE 5

| | | Comp. | Comp. | Comp. | Comp. |
|---|---|---|---|---|---|
| Measurement Item | | Example 1 | Example 2 | Example 3 | Example 4 |
| Viscosity (mPas) | | 41750 | 11600 | 64167 | 50920 |
| Creep (min) | | 2.3 | 5.1 | 1.9 | 2.6 |
| Evaluation of heat | | X | ◯ | X | X |
| resistance | | | | | |
| Tack (g/cm²) | 5° C. | 3003 | 1425 | 3860 | 422 |
| | 23° C. | 3900 | 2089 | 4620 | 987 |
| | 35° C. | 3330 | 4081 | 3462 | 1808 |
| Evaluation of | 5° C. | ◯ | X | ⊚ | X |
| initial | 23° C. | ⊚ | Δ | ⊚ | X |
| adhesive | 35° C. | ◯ | ⊚ | ◯ | Δ |
| strength | | | | | |

| | | | | |
|---|---|---|---|---|
| Evaluation of adhesive | ◯ | ◯ | ◯ | X |
| strength after curing | | | | |
| (durability) | | | | |

The measurement and evaluation methods will be described.

### Melt Viscosity

The viscosity at 130° C. of each moisture-curable hot-melt adhesive agent was measured in accordance with the method B defined in JAI 7-1991. For the measurement, a Brookfield viscometer and a No. 27 rotor were used.

### Heat Resistance (Creep)

A particle board (10.0 cm×10. cm×2 cm), which was allowed to stand in a thermostat at 25° C. for 12 hours or more, was used as a test material. The particle board was coated with each of the hot melt adhesives of Examples and Comparative Examples at 130° C. by a roll coater. The thickness of the coated adhesive agent was 70±10 μm.

A melamine board (13.0 cm×2.5 cm) and the particle board were laminated together by the coated adhesive. Specifically, the melamine board was set up so that it stuck 2 cm from the particle board, and both of the boards were laminated together by a roll press machine to serve as a creep test sample.

This sample was fixed at an upper part of the thermostat at 80° C. The sample was fixed so that the melamine board sticking out 2 cm was fixed on the lower side. After preheating the sample for one minute, a 245-g weight was hung on the tab portion which stuck out 2 cm (melamine board), and the time until the weight fell off was measured to evaluate creep properties.

Since the purpose of the present test is evaluation of the heat resistance (creep properties) before the reaction, a series of operations from coating until start of measurement was performed within 3 minutes.

Creep was evaluated by the time from the start of the measurement until an evaluation piece of the melamine board fell off. The evaluation criteria are as follows.

⊚: 7.0 minutes or more
◯: 5.0 minutes or more and less than 7.0 minutes
Δ: 3.0 minutes or more and less than 5.0 minutes
X: less than 3.0 minutes

### Initial Adhesive Strength (Tack)

On a 50 μm-thick PET film, each of hot-melt adhesive agents of Examples and Comparative Examples was coated to a thickness of 50 μm, and the PET film after coating was set in a Peltier thermal control unit.

Tack measurement was conducted using a tack tester in which a 5 mm-diameter plunger was set. The tack measurement was conducted at a pressing force during tack measurement of 1.5 kg/cm², a pressing time of one second, and a speed of 10 mm/sec when moving a plunger up and down.

The measurement was conducted under three temperature conditions. The present test is intended to evaluate the initial adhesive strength before the reaction, a series of operations from coating until start of measurement was performed within 3 minutes.

Evaluation criteria for the tack are as follows:

⊚: 3500 g/cm² or more
◯: 2500 g/cm² or more and less than 3500 g/cm²
Δ: 1500 g/cm² or more and less than 2500 g/cm² or less
X: less than 1500 g/cm²
Adhesive Strength after Curing (Durability)

A particle board (10.0 cm×10. cm×2 cm), which was allowed to stand in a thermostat at 25° C. for 12 hours or more, was used as a test material. The particle board was coated with each of the hot melt adhesives of Examples and Comparative Examples at 130° C. by a roll coater. The thickness of the coated adhesive agent was 70±10 μm.

A melamine board (13.0 cm×2.5 cm) and the particle board were laminated together through the coated adhesive agent to serve as a sample. After curing the sample at room temperature for one week or more, it was allowed to stand in a thermostat at 60° C. After left standing for 24 hours, the sample was taken out, and whether or not lifting or peeling occurs on the melamine board and the particle board was confirmed by visual inspection.

Evaluation criteria for the durability are as follows:

◯: No lifting or peeling was observed.
X: Lifting or peeling was observed.

As shown in Table 3, the moisture-curable hot-melt adhesive agents of the Examples are favorable in all the heat resistance (creep), initial adhesive strength (tack), and adhesive strength after curing (durability). In particular, a moisture-curable hot-melt adhesive agent of Example 1 has high creep performance that serves as an indication of heat resistance, and favorable initial adhesive strength (tack) at a wide temperature range of 5 to 35° C.

As shown in Table 5, moisture-curable hot-melt adhesive agents of the Comparative Examples have a poor balance of the creep, tack and durability, so that any of the evaluation items are indicated by “X”.

Therefore, it has been demonstrated that by including all the components (A), (B1), (B2) and (C), the moisture-curable hot-melt adhesive agent becomes excellent in the heat resistance, initial adhesive strength, and adhesive strength after curing.

### INDUSTRIAL APPLICABILITY

The present invention provides a moisture-curable hot-melt adhesive agent. The moisture-curable hot-melt adhesive agent is useful in producing layered products in various usages such as exterior and interior materials of building materials, flooring, lamination of a decorative sheet on a substrate, and profile wrapping.

1. A moisture-curable hot-melt adhesive agent comprising
an urethane prepolymer having an isocyanate group at the end (A),
a styrene based block copolymer (B), and
a tackifying resin (C), wherein
the styrene based block copolymer (B) comprises a styrene based block copolymer having 10 to 35% by weight of a styrene content (B1) and a styrene based block copolymer having 40 to 70% by weight of a styrene content (B2).

2. The moisture-curable hot-melt adhesive agent according to claim 1, wherein (B1) is a styrene-isoprene based block copolymer, and (B2) is a styrene-isoprene based block copolymer.

3. The moisture-curable hot-melt adhesive agent according to claim 1, wherein the moisture-curable hot-melt adhesive agent comprises 25 to 64 parts by weight of (A), 10 to 40 parts by weight of (B1) and 10 to 40 parts by weight of (B2), based on 100 parts by weight in total of (A) and (B).

4. The moisture-curable hot-melt adhesive agent according to claim 1, wherein the moisture-curable hot-melt adhesive agent comprises 60 to 110 parts by weight of the tackifying resin (C), based on 100 parts by weight in total of (A) and (B).

5. The moisture-curable hot-melt adhesive agent according to claim 1, wherein the styrene based block copolymer (B2) is a triblock copolymer.

6. A layered product comprising a substrate, an adhesive agent layer formed on a surface of the substrate and an adherend adhered to a surface of the adhesive agent layer, wherein the adhesive layer consists of the moisture-curable hot-melt adhesive agent according to claim 1.
